(19) United States
(12) Patent Application Publication
(10) Pub. No.: US 2017/0079286 A1
(43) Pub. Date: Mar. 23, 2017

(54) Raw Uncooked/Unbaked Dessert Rolls

(71) Applicants: Leonardo DeJesus Gomez, Miami, FL (US); Maria Cristina Gonzalez, Miami, FL (US)

(72) Inventors: Leonardo DeJesus Gomez, Miami, FL (US); Maria Cristina Gonzalez, Miami, FL (US)

(21) Appl. No.: 13/849,499

(22) Filed: Mar. 23, 2013

(51) Int. Cl. A21D 13/06; A21D 10/04; A21D 13/00

(52) U.S. Cl. CPC A21D 13/066; A21D 13/0022; A21D 10/04

(57) ABSTRACT

A method of preparation of raw, uncooked or unbaked dessert rolls is such that they are unbaked or uncooked in any conventional high temperature process exceeding 120 degrees Fahrenheit. The method includes using ingredients free from all refined sugars, eggs, flour, gluten, cholesterol, high fructose corn syrup, hydrogenated oils, or any artificial preservatives. In addition, the method of preparation is such that the dessert rolls obtain a “thin bun-like” exterior that maintains their consistency and does not crack when being rolled into the final product.

### BACKGROUND OF THE INVENTION

Field of the Invention

The present invention and embodiments relates to the manufacturing process of producing nonfattening uncooked/unbaked healthy dessert rolls. More particularly, the invention and embodiments relates to the method of manufacturing Raw Cinnamon Rolls, Raw Cacao Rolls, and other similar dessert roll products with different constitutes.

Description of the Related Art

The pursuit of healthier sustenance in their diets has led consumers to become more aware of what they are consuming. In recent years, consumers have been procuring healthier foods with higher nutritional values, and/or are reducing their daily caloric consumption for weight management purposes. As a result, consumers have been avoiding and have become almost fearful of sweets & desserts. This is a direct result of consumer's understanding of the high fattening, low nutritional, and the high caloric characteristic of conventionally processed sweets & desserts. In addition to these factors, conventionally processed sweets & desserts are also high in sugar, high in sodium, high in cholesterol; this a direct result of their primary ingredients generally consisting of refined sugars and/or high fructose corn syrup, artificial flavors, hydrogenated oils/and or refined oils, and refined flour. This pursuit has also resulted in the formation of specialty diets that are more personalized to the consumer's specific needs & wants including sodium free, gluten free, sugar free, cholesterol free, kosher, raw food, low carb, vegan, and vegetarian diets.

Over the course of years, consumers have developed a “Sweet Tooth” for sweets & desserts by having been accustomed to eating them as part of their regular diet. This has caused great difficulties with efforts to moderate, or even eliminate sweets & desserts from consumer's diets. In addition, chocolates desserts have been especially difficult to moderate or eliminate from consumer's diets because of the natural compounds contained in Raw Cacao that include Phenyl-ethylamine which is a natural mood enhancer, Theo-bromine which is mild antidepressant stimulant, and serotonin which helps creates feelings of well-being, happiness, and at peace in the body; these compounds make chocolates even more difficult to moderate or eliminate from consumer's diets.

### SUMMARY OF THE INVENTION

The manufacturing process of making healthy dessert rolls (e.g. Raw Cinnamon Rolls, Raw Cacao Rolls, and other similar dessert rolls with different constitutes) that maintain the health benefits of their natural ingredients intact without the need for cooking/baking or any artificial preservatives, and who's fruits and/or vegetable & nut based ingredients provide a non-fattening, low caloric, and nutritious alternative to conventionally processed sweets & desserts.

When we think about Dessert Rolls (Cinnamon Rolls or Chocolate Rolls), the first thought that usually comes to our minds are sugar-flour based desserts, that are fattening and provide no nutritional benefits. Raw dessert rolls (e.g. Raw Cinnamon Rolls, Raw Cacao Rolls, and other similar dessert rolls with different constitutes) are not baked and are prepared without any flour, refined sugars, eggs, yeast, or artificial ingredients and are non-fattening with a high nutritional value.
1. Similar to baked flour desserts, it is necessary that the batter mix that will become the outer shell of the raw dessert rolls coagulates its texture. This embodiment adds Flaxseeds to batter mix, which produces a natural coagulation agent that increases the consistency of the batter and results in maximum coagulation of its texture. The batter requires sitting after mixing in order to complete its coagulation.
2. It is necessary to spread the batter mix onto the Teflon sheets to be placed inside a food dehydrator in the exact dimensions and thickness in order to make the exterior “thin bun-like” outer shell. This embodiment uses an apparatus to spread the batter mix directly onto the Teflon sheets with the exact dimensions and thickness required.
3. Food dehydrators are usually used to produce food crackers that are hard & brittle, and impossible to bend or roll. This embodiment uses the food dehydrator for dehydrating the batter mix in a specific manner, thickness, and duration to produce a soft malleable “bun-like” consistency that can bend and be rolled into any shape, without cracking. By spreading the appropriate thickness and dimensions of the batter for the appropriate duration in the dehydrator; then, using a similar process on the opposite side, produces the soft malleable “thin bun-like” consistency that can bend into rolls.
4. The two part filling is completely uncooked, unbaked, or even dehydrator. This embodiment uses an apparatus to spread the two fillings (one at a time) onto the exterior “thin bun-like” outer shell to the exact dimensions and thickness required. The fillings are spread on top of the “thin bun-like” outer shell using the spreading apparatus that spreads the exact dimensions and thickness required. This allows the filling to be rolled without spilling on the sides or causing the “thin bun-like” outer shell to crack.
5. The two part filling requires a solid compressive force equivalent to 0.5 PSI in order for the filling to become embedded on to the “thin bun-like” outer shell. This embodiment uses a solid compressive force equivalent to 0.5 PSI that embeds the two fillings onto the soft malleable “thin bun-like” outer shell.
6. By being fruits and/or vegetable based and without using any artificial preservatives, these dessert roll products would be subject to perishability, with a limited shelf life. However, this embodiment uses the natural ingredient of Cinnamon, which is applied to the dessert rolls and then acts as a natural preservative to protect the dessert roll products from perishability and develops a long shelf life and freezing capabilities, without significant deteriorations.
7. The completed uncut dessert rolls have a unique texture that requires a specific cut with the exact thickness and measurement in order to maintain its texture and consistency. This embodiment uses an apparatus to produce the exact cut to the specific size & dimensions for the completed rolled food products.

These embodiments produce a dense nonfattening, healthy, nutritious, and low caloric dessert rolls, without cracks; that do not require any chemical preservatives to remain fresh, and are able to maintain a long shelf life, with freezing capabilities, and are gluten free, cholesterol free, and sodium free. These embodiments also produce a dense dessert rolls that are suited for specialty diets including sodium free, gluten free, cholesterol free, kosher, raw food, low carb, vegan, and vegetarian diets.

### BRIEF DESCRIPTION OF THE DRAWINGS

Having thus described the some of the embodiments of the invention in general terms, reference will now be made to the accompanying drawings, which are not necessarily drawn to scale, and wherein:

FIG. 1 illustrates the spread apparatus being used to spread the batter (1) onto the Teflon sheets (2) according to one embodiment of the present invention.

FIG. 2 illustrates the batter spread on the Teflon sheet (4), on the dehydrator tray (3) being placed inside the dehydrator according to one embodiment of the present invention.

FIG. 3 illustrates the spread apparatus spreading the filling #2 (5) on top of filling #1 onto the “thin bun-like” outer shell (6) having been removed from the dehydrator process, according to one embodiment of the present invention.

FIG. 3A illustrates applying manual compressive force of approximately 0.5 PSI (6a) to embed the two fillings onto the soft malleable “thin bun-like” outer shell according to one embodiment of the present invention.

FIG. 4 illustrates the “thin bun-like” outer shell (7) with spread filling #1 & 2 having already applied manual compressive force and being rolled according to one embodiment of the present invention.

FIG. 5 illustrates the “thin bun-like” outer shell with fillings (8) being rolled to completion to become raw unbaked and uncut dessert rolls according to one embodiment of the present invention.

FIG. 6 illustrates the complete uncut dessert rolls being cut according to the exact thickness and measurements with multiple blade cutting apparatus (9) which provides a sharp & clean cut according to one embodiment of the present invention.

FIG. 7 illustrates another angle of the complete uncut dessert rolls (10) being cut according to the exact thickness and measurements with the multiple blade cutting apparatus (11) according to one embodiment of the present invention.

FIG. 8 illustrates the manual spreading of the batter onto the Teflon sheets according to one embodiment of the present invention.

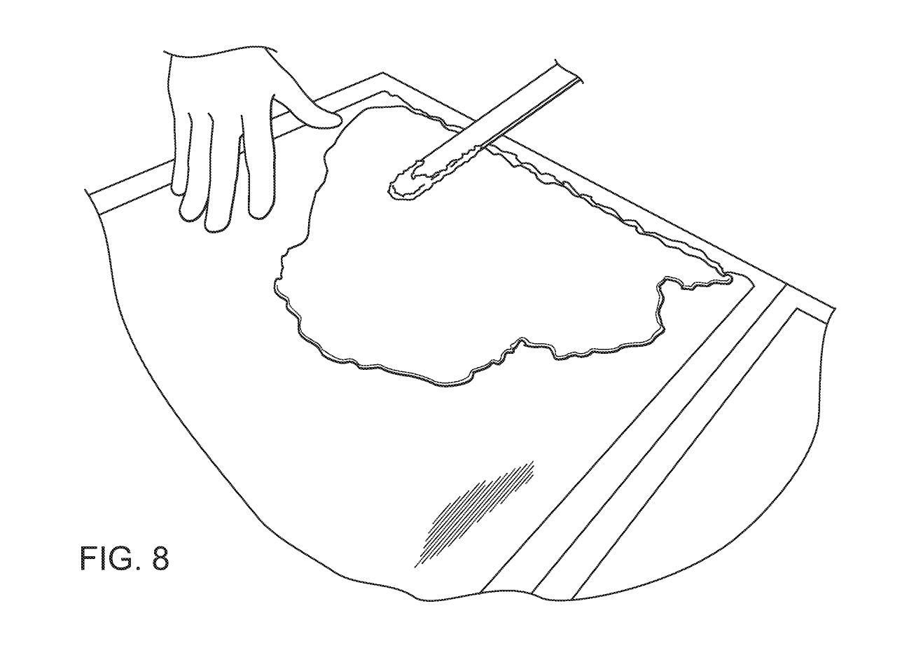

FIG. 9 illustrates the manual cutting of the complete dessert rolls according to the approximate thickness and measurement according to one embodiment of the present invention.

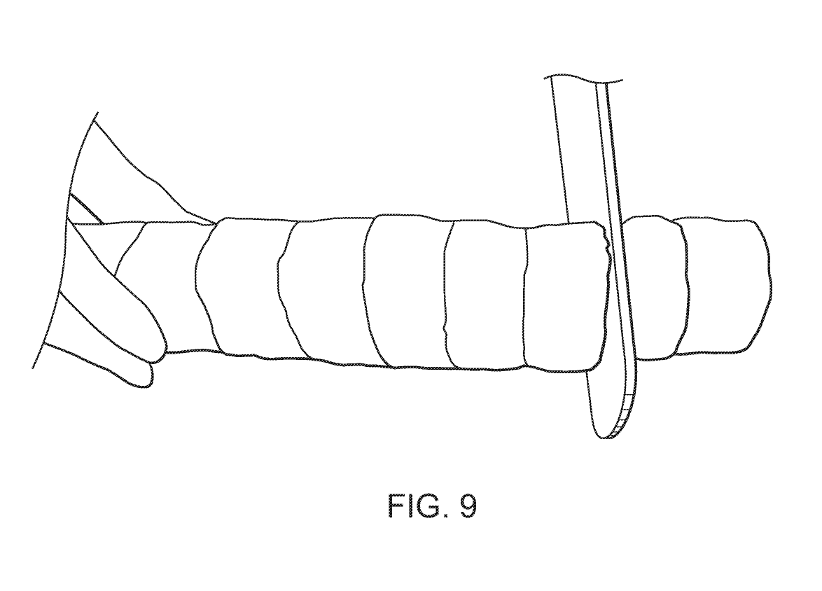

### DETAILED DESCRIPTION OF THE INVENTION

The manufacturing process and embodiments will be more fully described hereinafter with reference to the associated drawings, in which some examples of the details are demonstrated. However, this manufacturing process may be exemplified in various forms with various embodiments, and this example should not be construed as limits to the embodiments set forth herein; rather, these embodiments are provided by way of example so that this disclosure will satisfy applicable legal requirements.

A method according to one embodiment of the invention will be described in terms of a number of steps to be taken in order to manufacture the Raw dessert rolls (e.g. Raw Cinnamon Rolls, Raw Cacao Rolls, and other similar dessert rolls with different constitutes) described above in connection with the following figures.

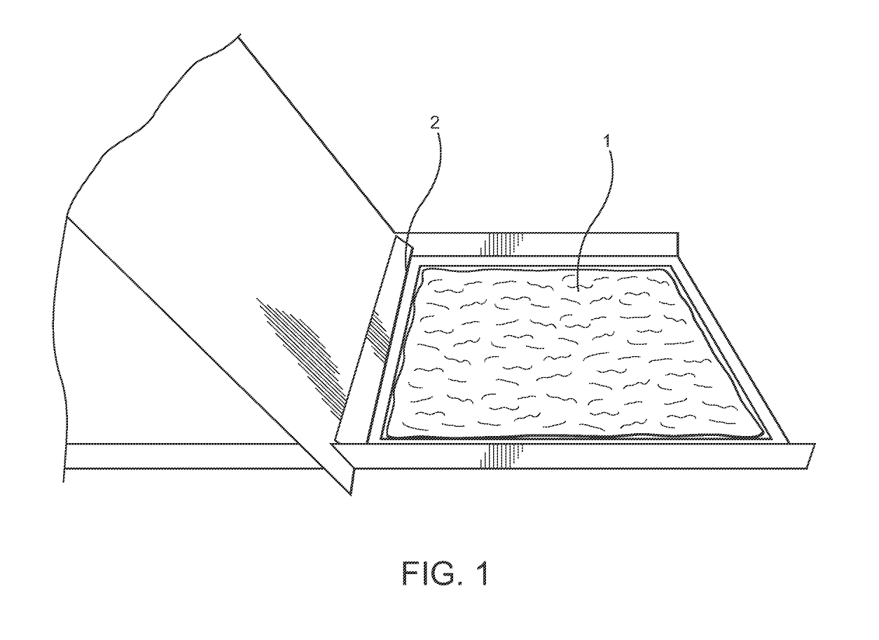

FIG. 1: The exemplifying method starts at a point in time when the batter of prime ingredients (1) having already completed the mixing step, and the setting time until the batter coagulates and becomes tacky, is spread onto the Teflon sheet (2) by using the spreading apparatus that spreads the batter evenly and to an exact thickness of ⅛ of an inch, by the dimensions of 10 inches by 14 inches.

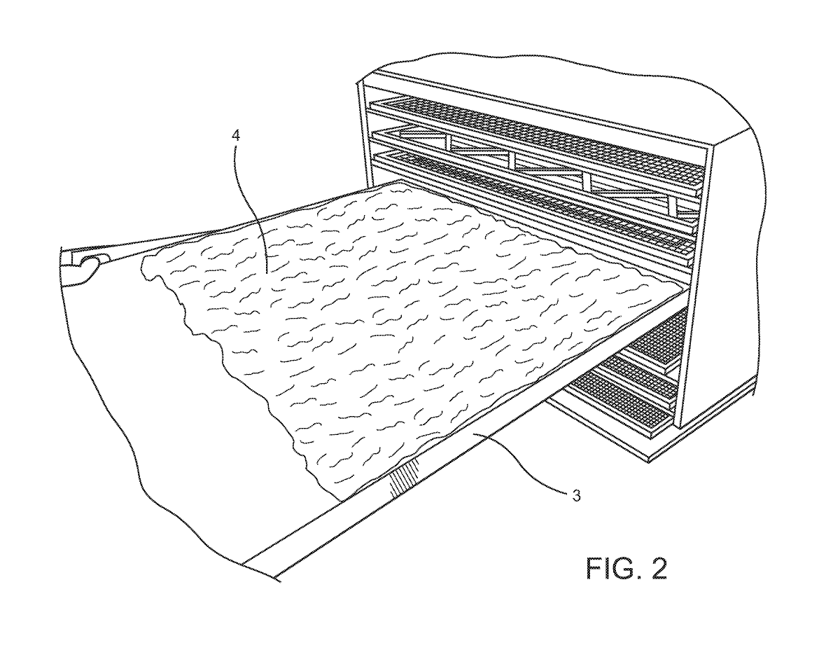

FIG. 2: The next step comprises of the batter mix, having been already spread evenly on the Teflon sheets (4) according to the previous step, are then placed onto the dehydrator tray (3) and then placed inside the dehydrator for approximately 6-12 hours depending on the desired roll: Raw Cinnamon Rolls require 12 hours, Raw Cacao Rolls require 6 hours at 115 degrees Fahrenheit. The following step comprises of turned over the batter onto the opposite side, and then being replaced inside dehydrator for one hour at temperatures of 115 degrees Fahrenheit. After this step is completed, the batter has now solidified into a soft malleable “thin bun-like” that can be rolled and will become the outer shell of the dessert.

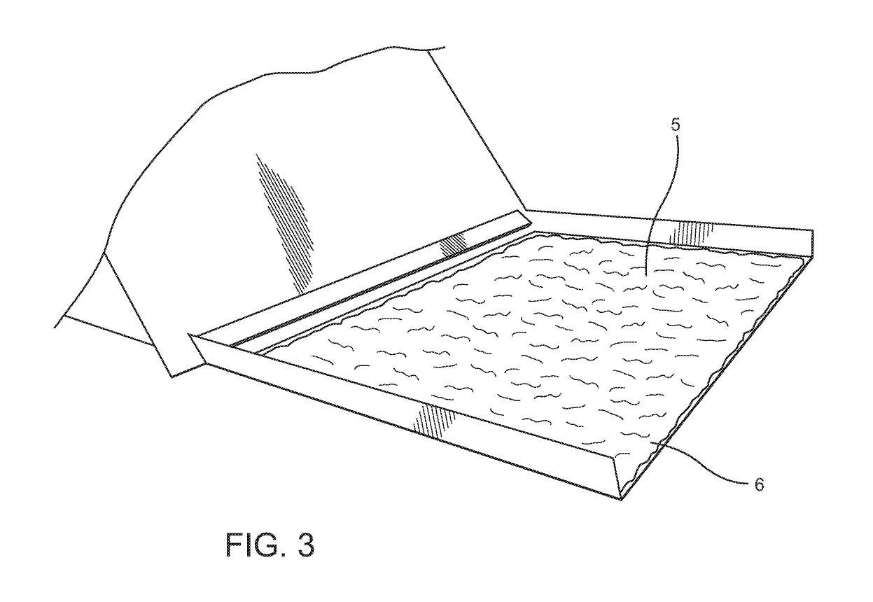

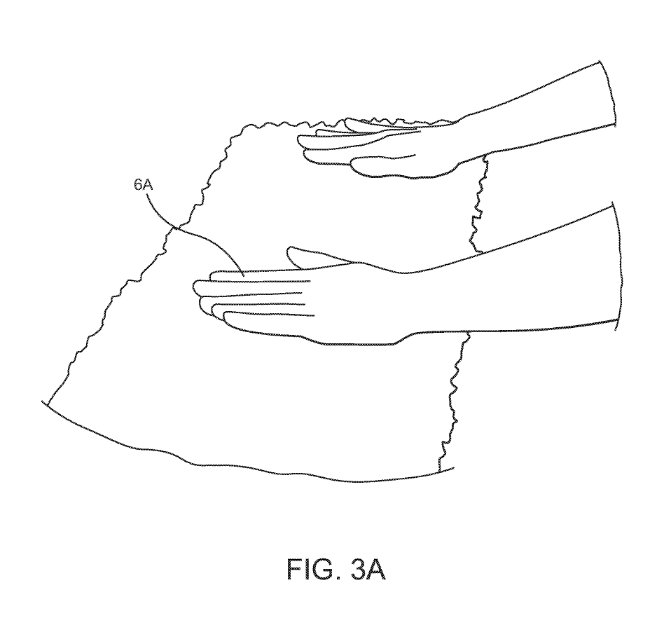

FIG. 3, 3A, 4: The next step comprises of the “thin bun-like” product being removed from the dehydrator and placed flat onto a production apparatus, where the filling spread #1 and #2 (5) are spread on top of each other using the spreading apparatus to exactly ¼ of an inch thick onto “flat bun-like product.” The following step comprises of applying a compressive force of 0.5 psi (6a) on top of the filling mix #1 & #2 and the “flat bun-like product” manually (7) or mechanically that will allow the layers to be embedded to the “thin bun-like” product. The following step comprises of leaving a 1 inch gap after the application of filling mix #2 (which exposes the tacky nature of filling #1) to be used as sealant to closed and hold closed the rolls. The following step comprises of applying the natural ingredient: Cinnamon to the raw unbaked dessert rolls (buns) which produces a natural preservative that results in a long shelf life and freezing capabilities.

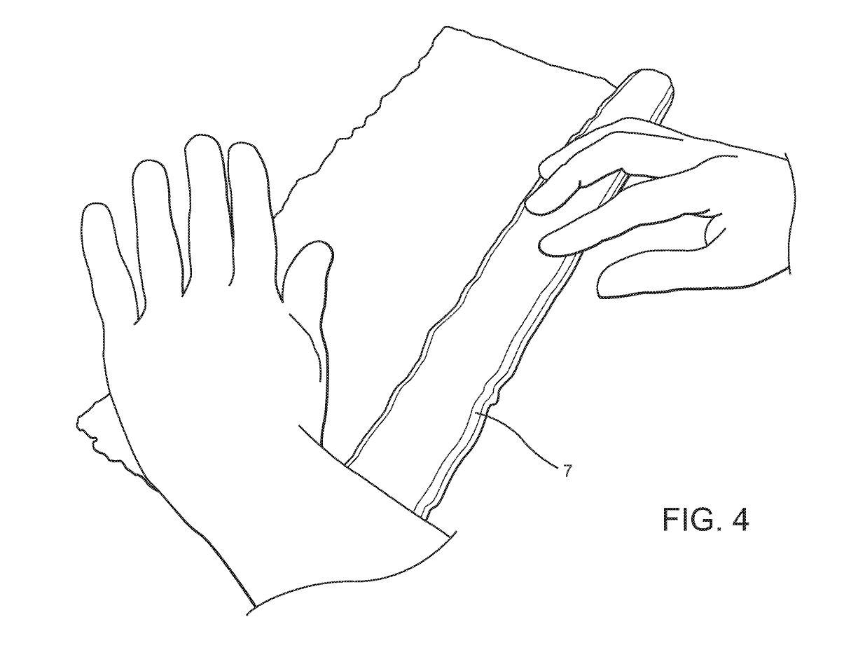

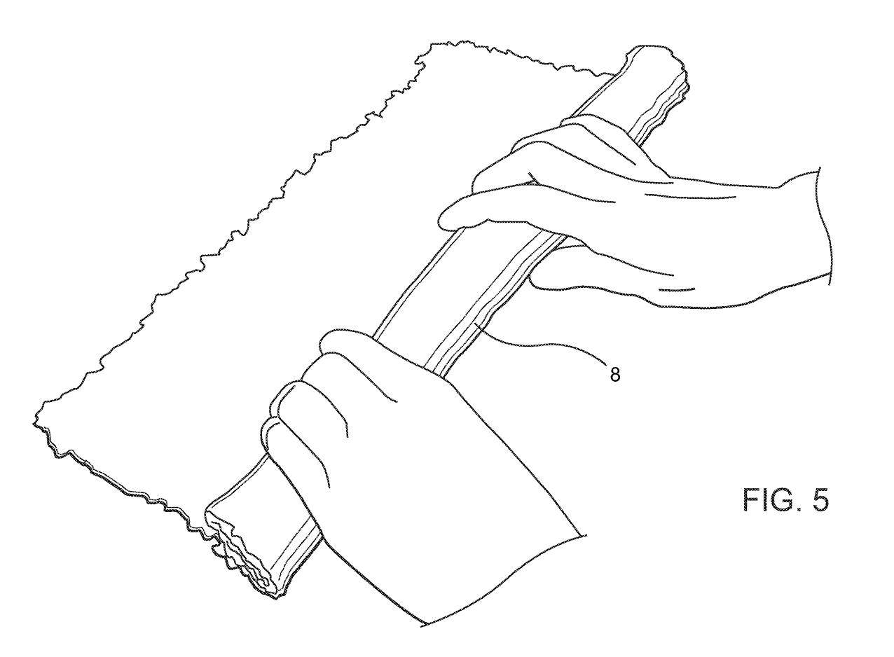

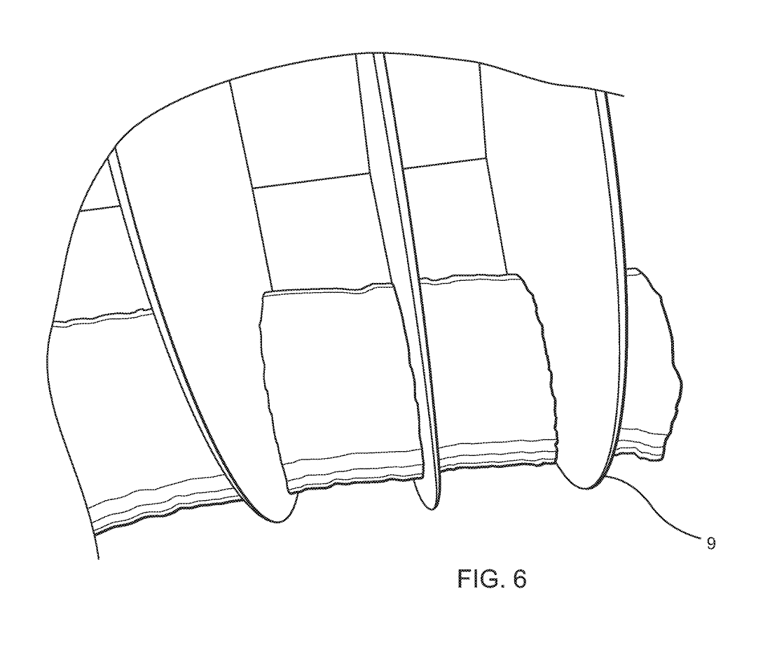

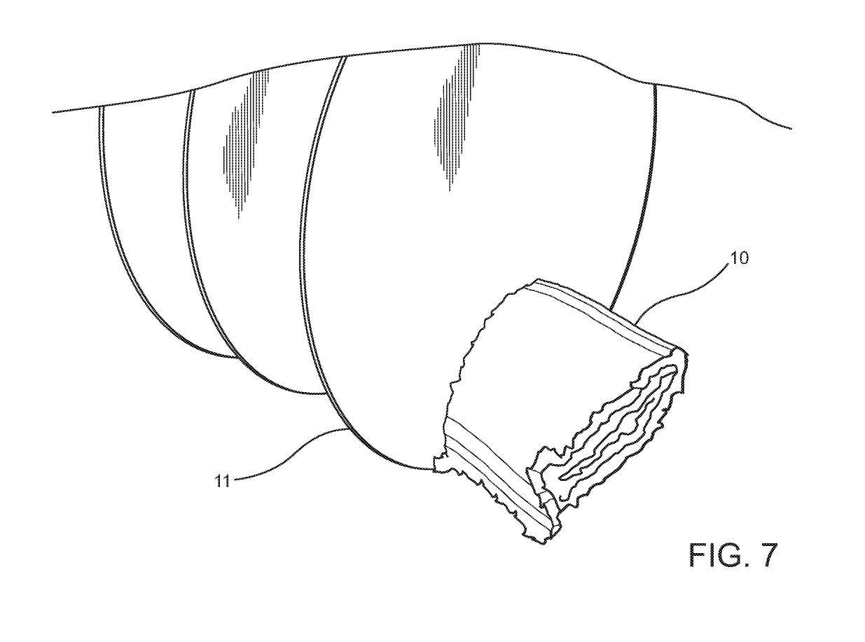

FIGS. 4, 5, 6, and 7: The next step comprises of rolling the completed “thin bun-like” product with fillings (7)(8) manually or mechanically by pinching opposite end to 1 inch gap and commencing the rolling process. The following step comprises of cutting the completed raw unbaked dessert rolls using a cutting apparatus (9) to the exact dimensions of 1 inch thick for the Raw Cinnamon Rolls, and ¾ inches thick for the Raw Cacao Rolls. The ends of the rolls (10) are discarded. The cutting apparatus leaves a clean sharp cut to both ends of the rolls (11).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

Now that the invention has been described,

What is claimed is:

1. A method for manufacturing Raw uncooked/unbaked dessert rolls (e.g. Raw Cinnamon Rolls, Raw Cacao Rolls, and other similar dessert rolls with different constitutes) comprising the steps of: adding prime ingredient for making the batter; adding a natural ingredient to make the batter coagulate; using spreading apparatus to spread batter evenly and to exact thickness & dimensions onto dehydrator sheets; dehydrating batter on sheets on both sides resulting in a soft malleable “flat bun-like product” that can be shaped or rolled; spreading filling mixes using spreading apparatus onto “flat bun-like product”; pounding with a solid compressive force on top; adding a natural ingredient to deliver a natural preservative; rolling the “flat bun-like product” with the fillings into Raw unbaked dessert rolls and sealing the rolls using the exposed filling gap as adhesive; cutting completed Raw unbaked dessert rolls using cutting apparatus into the specific weight & dimensions.

2. The method of claim 1, wherein mixing prime batter ingredients in an electric mixer or manually using a large mixing utensil.

3. The method of claim 1, further comprising by adding the natural ingredient: Flaxseeds to the batter produces a natural coagulation agent that increases the consistency of the batter, and results in the coagulation of the batter.

4. The method of claim 1, further comprising by adding a natural ingredient to the batter produces a natural coagulation agent that increases the consistency of the batter, and results in the coagulation of the batter.

5. The method of claim 1, further comprising after the mixing step is accomplished, letting batter sit for varying durations until complete coagulation and the consistency of the batter of a tacky texture is accomplished.

6. The method of claim 1, further comprising after the mixing step is accomplished, and the batter is left to sit for 30 minutes until the batter coagulates, and a tacky consistency is accomplished.

7. The method of claim 1, wherein after the mixing step is accomplished, the batter is continued to be mixed until the batter coagulates, and a tacky consistency is accomplished.

8. The method of claim 1, further comprising after the mixing step is accomplished and the batter coagulates, and is of a tacky consistency, the batter is spread onto dehydrator sheets, Teflon sheets, or other sheets of varying composition using a spreading apparatus to spread batter evenly and to the exact thickness and the dimensions required.

9. The method of claim 1, wherein after the mixing step is accomplished and the batter is spread onto dehydrator sheets, Teflon sheets, or other sheets of varying composition using a manual spreader to the approximate thickness and the approximate dimensions required.

10. The method of claim 1, further comprising the batter is placed in a dehydrator for approximately 6-12 hours depending on the desired roll: Raw Cinnamon Rolls require 12 hours, Raw Cacao Rolls require 6 hours at 115 degrees Fahrenheit.

11. The method of claim 1, wherein batter is placed in dehydrator for varying hours & varying temperatures depending on the desired rolls and the time constraints.

12. The method of claim 1, further comprising the batter is turned over to opposite side, and then replaced inside dehydrator for one hour at temperatures of 115 degrees Fahrenheit.

13. The method of claim 1, wherein batter is turned over to opposite side, and then replaced inside dehydrator for varying time & varying temperatures depending on desired rolls and time constraints.

14. The method of claim 1, further comprising a compressive force of 0.5 psi is applied mechanically to the filling mixes that have been already applied to the “flat bun-like product”.

15. The method of claim 1, wherein a compressive force is applied manually by pounding on to the filling mixes that have been already applied to the “flat bun-like product” with hands, rubber mallet, or roller.

16. The method of claim 1, further comprising leaving a 1 inch gap after the application of tacky filling mix #2 to be used as sealant for rolls.

17. The method of claim 1, further comprising closing the “flat bun-like product” with filling, using the gap as sealant into rolls.

18. The method of claim 1, further comprising by cutting the completed raw unbaked dessert rolls using a cutting apparatus to the exact dimensions and thickness required.

19. The method of claim 1, wherein manually cutting the completed raw unbaked dessert rolls using a cutting knife to the approximate dimensions using varying thicknesses.

20. The method of claim 1, further comprising by applying the natural ingredient: Cinnamon, to the raw unbaked dessert rolls (buns) produces a natural preservative that results in a long shelf life and freezing capabilities of the product.

21. The method of claim 1, wherein the raw unbaked dessert roll product comprises no gluten.

22. The method of claim 1, wherein the raw unbaked dessert roll product comprises no sodium.

23. The method of claim 1, wherein the raw unbaked dessert roll product comprises no cholesterol.

24. The method of claim 1, wherein the raw unbaked dessert roll product comprises a low caloric value.

25. The method of claim 1, wherein batter is not turned over to opposite side, but remains on the same side with the sheets removed from under, and then replaced inside dehydrator for varying time & varying temperatures depending on desired rolls and time constraints.

26. An apparatus used to spread the batter mix to the exact dimensions and thickness onto dehydrator sheets, Teflon sheets, or other sheets of varying composition.

27. The method of claim 26, further comprising a utensil is used to manually spread batter evenly to approximate dimensions onto dehydrator sheets, Teflon sheets, or other sheets of varying composition

28. An apparatus used to spread filling mixes to the exact dimensions and thickness onto the “flat bun-like product.”

29. The method of claim 28, further comprising a utensil is used to manually spread filling mixes evenly to approximate dimensions onto “flat bun-like product.”

30. An apparatus used to cut completed Raw Cinnamon Rolls, Raw Cacao Rolls, and other similar dessert rolls into the exact size and dimensions required.

31. The method of claim 30, further comprising a knife used to cut completed Raw Cinnamon Rolls, Raw Cacao Rolls, and other similar dessert rolls into the approximate dimension required.

32. A Raw uncooked/unbaked fruits and/or vegetable & nut based food dessert rolls.
